(19) United States
(12) Patent Application Publication
(10) Pub. No.: US 2004/0129862 A1
(43) Pub. Date: Jul. 8, 2004

(54) Wideband transimpedance amplifier with automatic gain control

(76) Inventor: Iain Ross McTaggart, Eden Prairie, MN (US)

Correspondence Address: SCHWEGMAN, LUNDBERG, WOESSNER & KLUTH, P.A., P.O. BOX 2938, MINNEAPOLIS, MN, 55402, US

(21) Appl. No.: 10/337,206

(22) Filed: Jan. 6, 2003

(51) Int. Cl. H01J 40/14

(52) U.S. Cl. 250/214 A

(57) ABSTRACT

This document describes systems and methods for providing an automatic gain control transimpedance interface apparatus for a photodiode. In one example, the interface apparatus includes a cascade of at least one gain stage. A voltage signal is fed back from a noninverting output of the at least one cascaded gain stage to a preceding noninverting input of the at least one cascaded gain stage. Another voltage signal is fed back from an inverting output of the at least one cascaded gain stage to a preceding inverting input of the at least one cascaded gain stage. The feedback configuration is believed to reduce peaking and/or pole shifting as the AGC varies the gain of the at least one gain stage. The AGC improves dynamic range utilization. One example provides a gain stage with a single pole frequency response and omits emitter-follower buffers between gain stages that produce hidden poles.

### TECHNICAL FIELD

This document relates generally to optical and electronic data communication systems and methods, and particularly, but not by way of limitation, to systems and methods for providing a wideband transimpedance amplifier with automatic gain control (AGC) for a photodiode.

### BACKGROUND

High-speed data communication often uses optical signals (light) communicated using optical fibers. Such optical fibers typically must interface with optoelectronic components, such as a transmitter that outputs an optical signal in response to an input electrical signal, or a receiver that detects a received optical signal and outputs a resulting electrical signal. The electronics of such optoelectronic components (e.g., a laser and accompanying circuitry of a transmitter, or a semiconductor diode light detector (“photodiode”), or other light detector, and accompanying circuitry of a receiver, or both) may be carried by or housed in an optical subassembly (OSA) module.

The receiver detects light received by a photodiode from an optical fiber. The photodiode is reverse-biased, such that the light received by the photodiode produces a resulting photocurrent. A transimpedance amplifier converts the photocurrent into a responsive voltage signal. The transimpedance amplifier may also provide voltage amplification of the responsive voltage signal. The present inventors have recognized an unmet need for providing a transimpedance amplifier photodiode interface that provides, among other things, a wide dynamic range and a substantially flat or predictable frequency response over a wide bandwidth.

### BRIEF DESCRIPTION OF THE DRAWINGS

In the drawings, which are offered by way of example, and not by way of limitation, and which are not necessarily drawn to scale, like numerals describe substantially similar components throughout the several views. Like numerals having different letter suffixes represent different instances of substantially similar components.

FIG. 1 is a schematic diagram illustrating generally, by way of example, but not by way of limitation, one embodiment of an interface apparatus for interfacing to a photodiode.

FIG. 2 is a schematic diagram illustrating generally, by way of example, but not by way of limitation, one embodiment of a gain stage.

FIG. 3 is a flow chart illustrating generally, by way of example, but not by way of limitation, one embodiment of a method of operating an interface apparatus.

FIG. 4 is a flow chart, similar to FIG. 3, illustrating generally, by way of example, but not by way of limitation, another embodiment of operating an interface apparatus.

### DETAILED DESCRIPTION

In the following detailed description, reference is made to the accompanying drawings, which form a part hereof, and in which is shown by way of illustration specific embodiments in which the invention may be practiced. These embodiments are described in sufficient detail to enable those skilled in the art to practice the invention, and it is to be understood that the embodiments may be combined, or that other embodiments may be utilized and that structural, logical and electrical changes may be made without departing from the scope of the present invention. The following detailed description is, therefore, not to be taken in a limiting sense, and the scope of the present invention is defined by the appended claims and their equivalents.

In this document, the terms “a” or “an” are used, as is common in patent documents, to include one or more than one. Furthermore, all publications, patents, and patent documents referred to in this document are incorporated by reference herein in their entirety, as though individually incorporated by reference. In the event of inconsistent usages between this documents and those documents so incorporated by reference, the usage in the incorporated reference(s) should be considered supplementary to that of this document; for irreconcilable inconsistencies, the usage in this document controls.

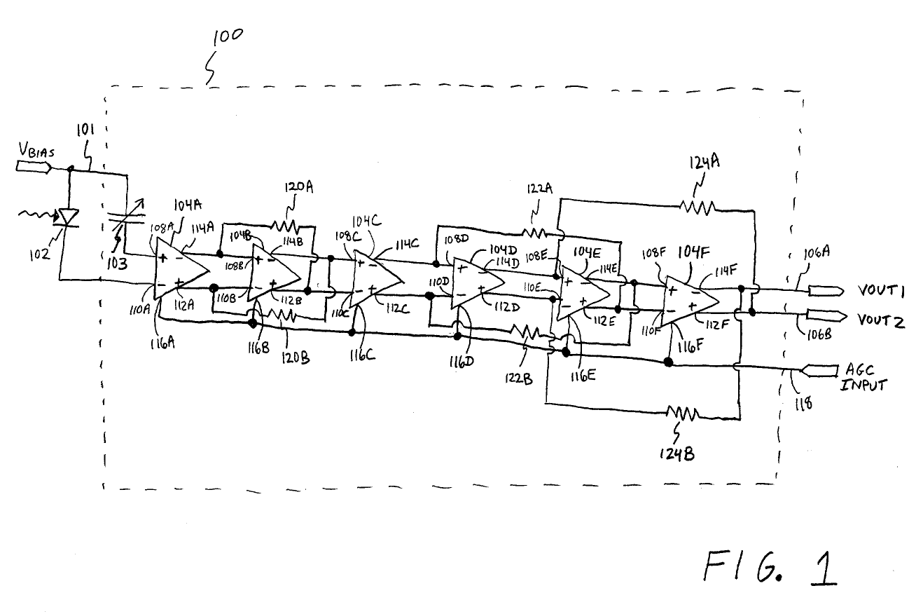

FIG. 1 is a schematic diagram illustrating generally, by way of example, but not by way of limitation, one embodiment of an interface apparatus 100 for interfacing to a photodiode 102. In one example, interface apparatus 100 and photodiode 102 are embodied in an optical receiver coupled to an optical fiber, where photodiode 102 receives a light signal from the optical fiber. In one example, interface apparatus 100 provides a transimpedance function; it converts a photocurrent (produced by photodiode 102 in response to the received light into a responsive voltage signal at output nodes 106A-B. In this example, interface apparatus 100 includes one or more cascaded gain stages 104A-F. Each gain stage 104A-F includes differential inputs and differential outputs. More particularly, each gain stage 104A-F respectively includes a corresponding noninverting input 108A-F, a corresponding inverting input 110A-F, a corresponding noninverting output 112A-F, and a corresponding inverting output 114A-F. The cascaded gain stages 104A-F are configured such that an inverting output 114 and a noninverting output 112 of a preceding stage in the cascade are respectively coupled to a noninverting input 108 and an inverting input 110 of the immediately subsequent stage in the cascade. For example, inverting output 114A and a noninverting output 112A of gain stage 104A are respectively coupled to a noninverting input 108B and an inverting input 110B of the immediately subsequent gain stage 104B; inverting output 114B and a noninverting output 112B of gain stage 104B are respectively coupled to a noninverting input 108C and an inverting input 110C of the immediately subsequent gain stage 104C; etc. In this example, interface apparatus 100 advantageously omits using emitter follower buffer stages between successive gain stages 104; this reduces or substantially eliminates the presence of hidden poles due to such emitter follower buffer stages.

In this example, photodiode 102 includes a cathode terminal coupled to inverting input 110A of the first gain stage 104A, and an anode terminal coupled to a regulated or other bias voltage node 101. In this example, interface apparatus 100 includes a programmably adjustable capacitor 103, having a capacitance value that is programmably adjusted to substantially match the capacitance of photodiode 102. This capacitance matching reduces or avoids mismatch in coupling of power supply or other noise at bias node 101 to inputs 108A and 110A of gain stage 104A. One example of such capacitance matching is described in McTaggart U.S. patent application Ser. No. ______ (Attorney Docket No. 01232.013US1), entitled “TRANSIMPEDANCE AMPLIFIER FOR PHOTODIODE,” assigned to MathStar, Inc., and filed on even date herewith, which is hereby incorporated by reference herein in its entirety, including its description of capacitance matching and common mode biasing.

In the example illustrated in FIG. 1, each gain stage 104 also includes a respective automatic gain control (AGC) input 116A-F, each of which is commonly coupled to an AGC input terminal 118 of interface apparatus 100. AGC input 118 provides feedback, using the signals at output nodes 106A-B, to more fully utilize the dynamic range of impedance apparatus 100 (while avoiding clipping of the output signal at nodes 106A-B) by adjusting the individual gains of gain stages 104A-F. In one example, the frequency bandwidth of the feedback signal at AGC input 118 is significantly lower than the frequency bandwidth of the signal at outputs 106A-B.

In this example, one or more of gain stages 104A-F includes feedback from a noninverting output to a noninverting input of the same or a preceding gain stage in the cascade, and similarly includes feedback from an inverting output to an inverting input of the same or a preceding gain stage in the cascade. This feedback is believed to provide improved frequency response of interface apparatus 100 by reducing or avoiding the movement in the pole frequencies as the AGC signal at 118 varies to control the gain of the individual gain stages 104A-F. In one example, such feedback includes a feedback resistor 120A between noninverting output 112B of gain stage 104B and noninverting input 108B of gain stage 104B, and a feedback resistor 120B between inverting output 114B of gain stage 104B and inverting input 110B of gain stage 104B. In a further example, such feedback additionally includes a feedback resistor 122A between noninverting output 112E of gain stage 104E and noninverting input 108D of gain stage 104D, and a feedback resistor 122B between inverting output 114E of gain stage 104E and inverting input 110D of gain stage 104D. In yet a further example, such feedback additionally includes a feedback resistor 124A between noninverting output 112F of gain stage 104F and noninverting input 108E of gain stage 104E, and a feedback resistor 124B between inverting output 114F of gain stage 104F and inverting input 110E of gain stage 104E. One advantage of the feedback configuration illustrated in FIG. 1 is that it increases the “flatness” of the frequency response of interface apparatus 100 and reduces peaking that otherwise might occur as the AGC gain is varied by the voltage at AGC input 118. In one example, one or more of resistors 120A-B, 122A-B, and 124A-B includes a programmable or otherwise adjustable resistance value. In one example, resistors 120A-B and 124A-B are fixed-value resistors and resistors 122A-B are programmably adjustable.

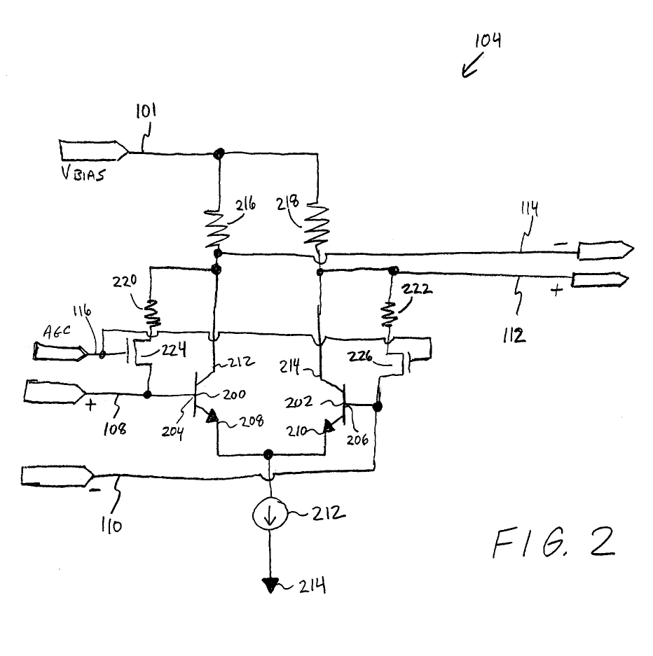

FIG. 2 is a schematic diagram illustrating generally, by way of example, but not by way of limitation, one embodiment of gain stage 104A-F. In this example, gain stage 104 includes noninverting input 108, inverting input 110, noninverting output 112, and inverting output 114. Input transistors 200 and 202 include corresponding control (e.g., base terminal) inputs 204 and 206 that are connected to respective noninverting input 108 and inverting input 110. In this example, input transistors 200 and 202 are illustrated as NPN bipolar junction transistors (BJTs), with corresponding emitters 208 and 210 connected to each other and to a common terminal of current source 212. The other terminal of current source 212 is connected to ground node 214. Input transistors 200 and 202 include corresponding collectors 212 and 214 that are respectively coupled to a regulated or other bias voltage node 101 through corresponding load resistors 216 and 218, respectively. Collector 212 is coupled to inverting output 114 of gain stage 104. Collector 214 is coupled to noninverting output 112 of gain stage 104. In this example, gain stage 104 also includes feedback resistor 220 and series-connected automatic gain control (AGC) transistor 224 between inverting output 114 and noninverting input 108, and feedback resistor 222 and series-connected AGC transistor 226 between noninverting output 112 and inverting input 110. In this example, AGC transistors 224 and 226 are illustrated as being field-effect transistors (FETs). A control (e.g., gate terminal) of each of AGC transistors 224 and 226 is commonly connected to AGC input terminal 116. In one example, gain stage 104 advantageously provides an approximately single pole frequency response.

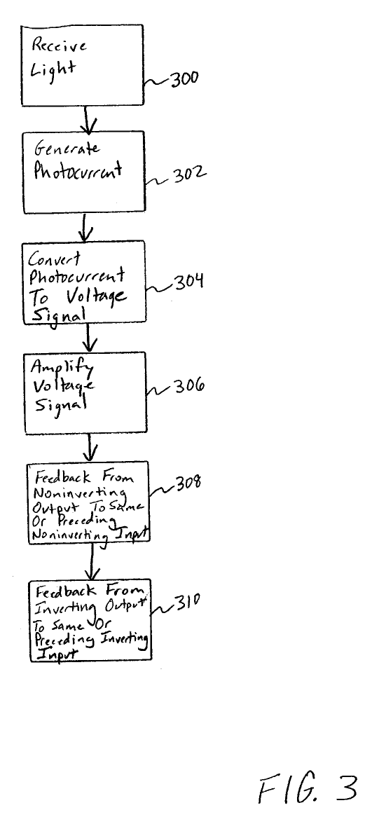

FIG. 3 is a flow chart illustrating generally, by way of example, but not by way of limitation, one embodiment of a method of operating interface apparatus 100. In this example, at 300, light is received, such as at photodiode 102. At 302, a photocurrent is generated by photodiode 102 using the received light. At 304, the photocurrent is converted to a voltage signal, such as by a first gain stage 104A (also referred to as a “transimpedance amplifier”) of interface apparatus 100. At 306, the resulting voltage signal is amplified, such as by subsequent cascaded gain stages 104B-F. At 308, an amplified voltage signal is fed back from a noninverting output of at least one of the cascaded gain stages 104A-F to the same or a previous cascaded gain stage 104A-F. At 310, an amplified voltage signal is fed back from an inverting output of at least one of the cascaded gain stages 104A-F to the same or a previous cascaded gain stage 104A-F. The order of the operations illustrated in FIG. 3 provides one conceptualization of certain techniques; in other conceptualization, one or more of these operations is carried out in a different order, or concurrently with one or more of the other illustrated operations.

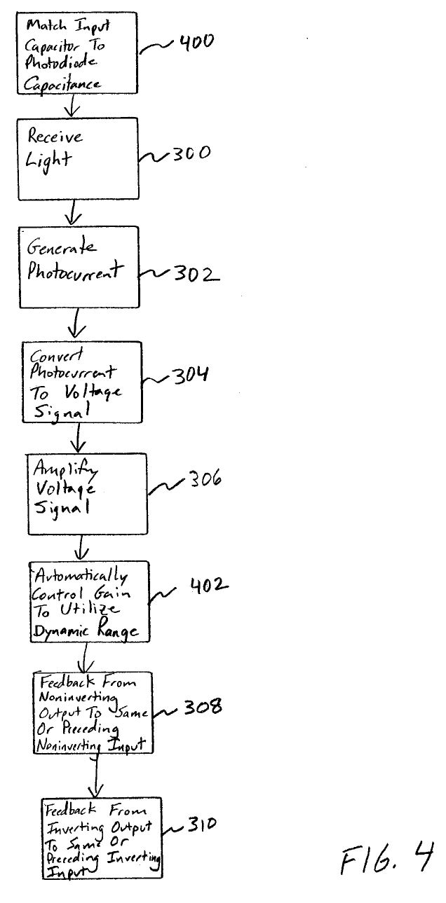

FIG. 4 is a flow chart, similar to FIG. 3, illustrating generally, by way of example, but not by way of limitation, another embodiment of operating interface apparatus 100. This example further includes matching, at 400, the capacitance value of programmably adjustable input capacitor 103 to the capacitance of photodiode 102, such as discussed and incorporated above. This example also includes automatically controlling a gain at 402 (such as that of one or more of cascaded gain stages 104A-F) to more fully utilize the dynamic range of interface apparatus 100 while substantially avoiding (or at least reducing) clipping of the resulting voltage signal at outputs 106A-B. The order of the operations illustrated in FIG. 4 provides one conceptualization of certain techniques; in other conceptualization, one or more of these operations is carried out in a different order, or concurrently with one or more of the other illustrated operations.

It is to be understood that the above description is intended to be illustrative, and not restrictive. For example, the above-discussed embodiments may be used in combination with each other. In another example, FETs are substituted for BJTs, or vice-versa. In a further example, interface apparatus 100 may include one or more additional gain stages 104 beyond those illustrated in FIG. 1. Many other embodiments will be apparent to those of skill in the art upon reviewing the above description. The scope of the invention should, therefore, be determined with reference to the appended claims, along with the full scope of equivalents to which such claims are entitled. In the appended claims, the terms “including” and “in which” are used as the plain-English equivalents of the respective terms “comprising” and “wherein.” Moreover, the terms “first,” “second,” “third,” etc. are used merely as labels, and are not intended to impose numeric requirements on their objects.

What is claimed is:

1. An apparatus for interfacing to a photodiode light sensor, the apparatus comprising:
a differential input/output first gain stage including a first noninverting input, a first inverting input, a first inverting output, a first noninverting output, and a first automatic gain control (AGC) input;
a differential input/output second gain stage including a second noninverting input, a second inverting input, a second inverting output, a second noninverting output, and a second AGC input, wherein the second noninverting input is coupled to the first inverting output, the second inverting input is coupled to the second noninverting output, and the second AGC input is coupled to the first AGC input;
a first feedback impedance, coupled between the second noninverting output and the second noninverting input; and
a second feedback impedance, coupled between the second inverting output and the second inverting input.

2. The apparatus of claim 1, further comprising:
a differential input/output third gain stage, including a third noninverting input, a third inverting input, a third inverting output, a third noninverting output, and a third AGC input, wherein the third noninverting input is coupled to the second inverting output, the third inverting input is coupled to the second noninverting output, and the third AGC input is coupled to the second AGC input;
a differential input/output fourth gain stage, including a fourth noninverting input, a fourth inverting input, a fourth inverting output, a fourth noninverting output, and a fourth AGC input, wherein the fourth noninverting input is coupled to the third inverting output, the fourth inverting input is coupled to the third noninverting output, and the fourth AGC input is coupled to the third AGC input;
a differential input/output fifth gain stage, including a fifth noninverting input, a fifth inverting input, a fifth inverting output, a fifth noninverting output, and a fifth AGC input, wherein the fifth noninverting input is coupled to the fourth inverting output, the fifth inverting input is coupled to the fourth noninverting output, and the fifth AGC input is coupled to the fourth AGC input;
a third feedback impedance, coupled between the fifth noninverting output and the fourth noninverting input; and
a fourth feedback impedance, coupled between the fifth inverting output and the fourth inverting input.

3. The apparatus of claim 2, further comprising:
a differential input/output sixth gain stage, including a sixth noninverting input, a sixth inverting input, a sixth inverting output, a sixth noninverting output, and a sixth AGC input, wherein the sixth noninverting input is coupled to the fifth noninverting output, the sixth inverting input is coupled to the fifth noninverting output, and the sixth AGC input is coupled to the fifth AGC input;
a fifth feedback impedance, coupled between the sixth noninverting output and the fifth noninverting input; and
a sixth feedback impedance, coupled between the sixth inverting output and the fifth inverting output.

4. The apparatus of claim 3, in which at least one of the first, second, third, fourth, fifth, and sixth gain stages comprises:
a bias voltage node;
a first input transistor, including a first control terminal coupled to the corresponding noninverting input of the at least one of the first, second, third, fourth, fifth, and sixth gain stages, a first emitter/source terminal, and a first collector/drain terminal coupled to the corresponding inverting output of the at least one of the first, second, third, fourth, fifth, and sixth gain stages;
a second input transistor, including a second control terminal coupled to the corresponding inverting input of the at least one of the first, second, third, fourth, fifth, and sixth gain stages, a second emitter/source terminal coupled to the first emitter/source terminal of the first input transistor, and a second collector/drain terminal coupled to the corresponding noninverting output of the at least one of the first, second, third, fourth, fifth, and sixth gain stages;
a first load impedance, coupled between the first collector/drain terminal and the bias voltage node;
a second load impedance, coupled between the second collector/drain terminal and the bias voltage node;
a first feedback impedance, coupled between the first collector/drain terminal and the corresponding noninverting input of the at least one of the first, second, third, fourth, fifth, and sixth gain stages;
a second feedback impedance, coupled between the second collector/drain terminal and the corresponding inverting input of the at least one of the first, second, third, fourth, fifth, and sixth gain stages;
a first AGC transistor, coupled in series with the first feedback impedance, the first AGC transistor including a control terminal coupled to the corresponding AGC input of the at least one of the first, second, third, fourth, fifth, and sixth gain stages; and
a second AGC transistor, coupled in series with the second feedback impedance, the second AGC transistor including a control terminal coupled to the corresponding AGC input of the at least one of the first, second, third, fourth, fifth, and sixth gain stages.

5. The apparatus of claim 4, in which the at least one of the first, second, third, fourth, fifth, and sixth gain stages further comprises:
a ground node; and
a current source, the current source including a first current source terminal coupled to each of the emitter/source terminals of the respective first and second input transistors, the current source further including a second current source terminal coupled to the ground node.

6. The apparatus of claim 3, in which at least one of the first, second, third, fourth, fifth, and sixth feedback impedances includes an adjustable resistor.

7. The apparatus of claim 1, in which at least one of the first and second gain stages comprises:
a bias voltage node;
a first input transistor, including a first control terminal coupled to the corresponding noninverting input of the at least one of the first and second gain stages, a first emitter/source terminal, and a first collector/drain terminal coupled to the corresponding inverting output of the at least one of the first and second gain stages;
a second input transistor, including a second control terminal coupled to the corresponding inverting input of the at least one of the first and second gain stages, a second emitter/source terminal coupled to the first emitter/source terminal of the first input transistor, and a second collector/drain terminal coupled to the corresponding noninverting output of the at least one of the first and second gain stages;
a first load impedance, coupled between the first collector/drain terminal and the bias voltage node;
a second load impedance, coupled between the second collector/drain terminal and the bias voltage node;
a first feedback impedance, coupled between the first collector/drain terminal and the corresponding noninverting input of the at least one of the first and second gain stages;
a second feedback impedance, coupled between the second collector/drain terminal and the corresponding inverting input of the at least one of the first and second gain stages;
a first AGC transistor, coupled in series with the first feedback impedance, the first AGC transistor including a control terminal coupled to the corresponding AGC input of the at least one of the first and second gain stages; and
a second AGC transistor, coupled in series with the second feedback impedance, the second AGC transistor including a control terminal coupled to the corresponding AGC input of the at least on of the first and second gain stages.

8. The apparatus of claim 7, further comprising a current source, the current source including a first current source terminal coupled to each of the emitter/source terminals of the respective first and second input transistors, the current source further including a second current source terminal coupled to the ground node

9. The apparatus of claim 1, further comprising:
a bias voltage; and
a programmably adjustable capacitor coupled between the first noninverting input and the bias voltage, the adjustable capacitor sized to substantially match a photodiode capacitance.

10. The apparatus of claim 9, further comprising a photodiode coupled between the first inverting input and the bias voltage.

11. The apparatus of claim 1, further comprising:
a bias voltage; and
a photodiode coupled between the first inverting input and the bias voltage.

12. An automatic gain control (AGC) gain stage apparatus comprising:
a bias voltage node;
an AGC input node;
a ground node;
a first input transistor, including a first control terminal providing a noninverting gain stage input, a first emitter/source terminal, and a first collector/drain terminal providing an inverting gain stage output;
a second input transistor, including a second control terminal providing an inverting gain stage input, a second emitter/source terminal coupled to the first emitter/source terminal of the first input transistor, and a second collector/drain terminal providing a noninverting gain stage output;
a first load impedance, coupled between the first collector/drain terminal and the bias voltage node;
a second load impedance, coupled between the second collector/drain terminal and the bias voltage node;
a first feedback impedance, coupled between the first collector/drain terminal and the noninverting gain stage input;
a second feedback impedance, coupled between the second collector/drain terminal and the inverting gain stage input;
a first AGC transistor, coupled in series with the first feedback impedance, the first AGC transistor including a control terminal coupled to the AGC input node;
a second AGC transistor, coupled in series with the second feedback impedance, the second AGC transistor including a control terminal coupled to the AGC input node; and
a current source, the current source including a first current source terminal coupled to each of the emitter/source terminals of the respective first and second input transistors, the current source further including a second current source terminal coupled to the ground node.

13. An apparatus including the AGC gain stage apparatus of claim 12, and further comprising a programmably adjustable capacitor coupled between the noninverting gain stage input and the bias voltage, the adjustable capacitor sized to substantially match a photodiode capacitance.

14. The apparatus of claim 13, further comprising a photodiode coupled between the inverting gain stage input and the bias voltage.

15. A method comprising:
receiving light at a photodiode;
generating a photocurrent using the received light;
converting the photocurrent into a responsive voltage signal;
amplifying the voltage signal using at least one cascaded gain stage, each of the at least one gain stages including a noninverting input, an inverting input, an inverting output, and a noninverting output;
feeding back a first amplified voltage signal from a noninverting output of the at least one cascaded gain stage to a preceding noninverting input of the at least one cascaded gain stage; and
feeding back a second amplified voltage signal from an inverting output of the at least one cascaded gain stage to a preceding inverting input of the at least one cascaded gain stage.

16. The method of claim 15, further comprising automatically adjusting a gain of the at least one gain stage using feedback output from a last one of the at least one cascaded gain stage.

17. The method of claim 15, further comprising programming a capacitance value of an adjustable capacitor, located on an integrated circuit with a transimpedance amplifier, to match a capacitance of the photodiode.
